(19) United States
(12) Patent Application Publication
(10) Pub. No.: US 2026/0009365 A1
(43) Pub. Date: Jan. 8, 2026

(54) THRUST REVERSER COMPRISING AN IMPROVED SYSTEM FOR TRANSLATABLY ACTUATING THE MOVABLE STRUCTURE OF THE REVERSER

(71) Applicant: SAFRAN NACELLES, Gonfreville-l'Orcher (FR)

(72) Inventors: Gina FERRIER, Moissy-Cramayel (FR); Vincent Jean-François PEYRON, Moissy-Cramayel (FR); Patrick André BOILEAU, Moissy-Cramayel (FR)

(73) Assignee: SAFRAN NACELLES, Gonfreville-l'Orcher (FR)

(21) Appl. No.: 18/992,298

(22) PCT Filed: Jul. 24, 2023
(86) PCT No.: PCT/FR2023/051148

§ 371 Date: Jan. 8, 2025

(30) Foreign Application Priority Data
Jul. 26, 2022 (FR) FR2207680

(51) Int. Cl. F02K 1/76; F02K 1/72

(52) U.S. Cl. CPC F02K 1/763; F02K 1/72; F05D 2220/323

(57) ABSTRACT

A thrust reverser for an aircraft propulsion unit, the reverser having a movable structure translatably movable relative to a fixed structure between an advanced direct thrust position and a retracted reverse thrust position, the reverser including an actuating system for moving the movable structure, including one or more actuators each with an actuating member that is translatably movable and centred on an actuating axis, the two movable reverser cowls being arranged symmetrically with respect to each other in a first median plane of the reverser. Among the actuator(s) of the actuating system, an eccentric actuator is provided, the actuating axis of which is offset circumferentially with respect to the first median plane.

### TECHNICAL FIELD

The invention relates to the field of nacelles and thrust reversers for aircraft propulsion units, and, more particularly, to the system for translatably actuating the movable structure of the reversers.

### PRIOR ART

Thrust reversers are devices that deflect the airflow passing through the propulsion unit forward, so as to shorten landing distances and limit the use of brakes on the landing gear.

The cascade reversers currently used in the aeronautical sector comprise deflection cascades integrated into a fixed or movable structure of the reverser. The movable structure of the reverser includes one or more movable reverser cowls, and it is translatably mounted relative to the fixed structure between an advanced direct thrust position, and a retracted reverse thrust position.

In the retracted reverse thrust position, to deflect at least part of the secondary flow towards the cascades, the reverser is usually equipped with shutter flaps, which, when deployed, at least partially close the secondary flow path. In a known manner, this forces the air of the secondary flow radially outwards, towards the cascades, which then generate the counter-thrust air flow forward. The flaps are generally pivotally mounted on the radially internal wall of the movable reverser cowls, this wall delimiting the secondary flow path radially outwards.

To ensure the translational movement of the moving part, the reverser comprises an actuating system usually made up of several actuators, distributed circumferentially.

In order to limit the mass and costs of the reverser, and thus reduce harmful emissions (CO, CO₂, NOₓ, etc.) in order to contribute to reducing the environmental impact of aircraft, it may be considered to reduce the number of actuators within the actuating system, while ensuring the desired functionalities, both in normal operating mode and in the event of a malfunction of one or more actuators. In particular, these actuators ensure the recovery of the aerodynamic forces exerted on the movable reverser cowls, in particular during the thrust reversal phase.

Usually, in order to ensure uniform recovery of forces by the actuators, they are arranged symmetrically with respect to a median plane of the reverser, generally a vertical and longitudinal median plane when the propulsion unit is intended to be suspended under a wing of the aircraft. Reducing the number of actuators may lead to arranging one of them on this same median plane, as is known for example from document FR 2 980 173 A1. However, in an architecture called “C” or “D” reverser movable cowl architecture, the actuator centered on the median plane is in a locking interface area of two movable cowls in the folded operating position. This creates potential difficulties in installing this actuator, given that the locking interface area of the movable cowls, in the 6 o'clock position, typically remains an area that is already heavily cluttered by the presence of equipment and ancillaries.

In addition, whether the movable cowl architecture is a “C”, “D” or “O” architecture, the installation of an actuator in this 6 o'clock position can locally result in an increase in the radial dimension towards the bottom of the nacelle, potentially incompatible with the need to maintain sufficient ground clearance for the engine assembly.

### DESCRIPTION OF THE INVENTION

To address the issues set out above, the invention relates to a propulsion unit for an aircraft, comprising the features of claim 1.

The invention is thus similar to a technological breakthrough, allowing to consider a reduction in the number of actuators of the movable structure, without providing an actuator at the area located opposite the attachment mast corresponding to an area cluttered with locking interface between the two movable reverser cowls in the “C” and “D” reverser configurations, nor an actuator arranged symmetrically to the eccentric actuator, in relation to the first median plane of the reverser.

Also, regardless of the reverser configuration chosen and the number of movable cowls resulting therefrom, the eccentric nature of the actuator located opposite the mast allows to overcome the problem of increasing the radial dimension of the nacelle towards the ground. Advantageously, the installation of this eccentric actuator does not have a negative impact on the ground clearance of the propulsion unit.

By reducing the number of actuators, cost advantages arise, particularly in terms of component costs and assembly costs.

This also results in a reduction in the mass of the reverser, via the removal of certain actuators and their associated fixing means.

Due to the removal of these means for fixing the actuators, an increase in the surface of the movable cowls which can be equipped with an acoustic coating is also advantageously observed.

Additionally, by reducing the number of actuators, better aerodynamic performance results from the reduction in the number of access hatches to these actuators.

Finally, in the case of two movable cowls arranged symmetrically with respect to the first median plane, since the eccentric actuator is not located in the cluttered locking interface area of these two movable cowls, its installation is greatly facilitated. Obviously, any other actuators constituting the actuating system can be disposed relatively freely, so as to guarantee the desired functionalities, both in normal operating mode and in the event of a malfunction of one or more of these actuators.

In addition, the actuating system consists of an odd number of actuators, preferably three or five, the actuators being distributed relative to each other circumferentially in a regular or irregular manner. This means that the angles between two directly consecutive actuators can be equal, or different. According to a possibility falling within the scope of the invention, the actuating system consists of a single actuator.

The invention preferably provides at least one of the following optional technical features, taken alone or in combination.

Preferably, the actuating system consists of three actuators, including:
the eccentric actuator;
two other actuators arranged on either side of the first median plane, preferably symmetrically with respect to this first median plane.

Preferably, in the case of two movable cowls arranged symmetrically with respect to the first median plane, the eccentric actuator is located close to the locking means of the movable reverser cowls.

Preferably, one of said two movable reverser cowls includes a beam on which are secured:
means for guiding the movable reverser cowl in translation;
an attachment fitting for the movable actuating member of the eccentric actuator;
a part of the locking means for the two movable cowls.

This beam thus advantageously integrates several functions, for a gain in compactness and mass.

Preferably, a fixed part of the eccentric actuator is fixed on a front frame of the deflection cascade support, or on a fixed longitudinal beam of the reverser, extending rearwardly from the front frame of the cascade support.

Preferably, the reverser comprises, associated with at least one of said one or two movable reverser cowls, at least one member for limiting the bending of said cowl in the retracted reverse thrust position, in the event of a malfunction of one or more actuators.

Preferably, the reverser has a C-shaped, D-shaped or O-shaped cowl architecture. The invention also applies to an inversion cascade belonging to the fixed structure of the reverser, or to its movable structure.

Other advantages and features of the invention will become apparent in the detailed, non-limiting description below.

### BRIEF DESCRIPTION OF THE DRAWINGS

The following detailed description refers to the appended drawings wherein:

FIG. 1 is a schematic half-view in longitudinal section of a propulsion unit, comprising a thrust reverser shown in direct thrust configuration;

FIG. 2 is a more detailed half-view of the reverser equipping the propulsion unit shown in FIG. 1, with the reverser being in the form of a preferred embodiment of the invention, and shown in the thrust reverser configuration;

FIG. 3 is a schematic cross-sectional view of the reverser shown in the preceding figures, the left part showing the cowls in the folded operating position, and the right part showing the cowls in the open maintenance position;

FIG. 4 is a schematic cross-sectional view similar to the preceding one, more detailed, and showing the cowls both in the folded operating position, and in the open maintenance position, this figure being taken along line IV-IV of FIG. 5;

FIG. 5 is a bottom view showing the reverser cowls shown in the preceding figures, the cowls being in the folded operating position;

FIG. 6 is a schematic cross-sectional view of the reverser, also taken along line IV-IV of FIG. 5, and wherein the positioning of the reverser actuators has been schematically shown;

FIG. 6A is a schematic cross-sectional view of the reverser similar to that of the previous one, showing an alternative embodiment;

FIG. 7 is a bottom view of the reverser, similar to FIG. 5, and wherein more detailed elements of the invention have been shown;

FIG. 8 is a bottom view of one of the two reverser cowls shown in the preceding figure;

FIG. 9 is a sectional view taken along line IX-IX of FIG. 7;

FIG. 10 is a schematic view showing an alternative for fixing an actuator to the fixed structure of the reverser;

FIG. 11 is a schematic view showing another alternative for fixing an actuator to the fixed structure of the reverser;

FIG. 12 is a schematic view showing a solution for limiting the bending of the movable reverser cowl, with this cowl shown in the advanced direct thrust position;

FIG. 13 is a schematic view similar to the previous one, with the movable cowl shown in the retracted reverse thrust position;

FIG. 14 is a schematic view showing another solution for limiting the bending of the movable reverser cowl, with this cowl shown in the advanced direct thrust position;

FIG. 15 is a schematic view similar to the previous one, with the movable cowl shown in the retracted reverse thrust position;

FIG. 16 is a schematic view showing yet another solution for limiting the bending of the movable cowl of the reverser, the movable cowl not being shown in this figure; and

FIG. 17 is a schematic cross-sectional view of the reverser similar to that of FIG. 3, according to an alternative embodiment wherein the reverser has an “O” configuration.

### DETAILED DESCRIPTION OF EMBODIMENTS

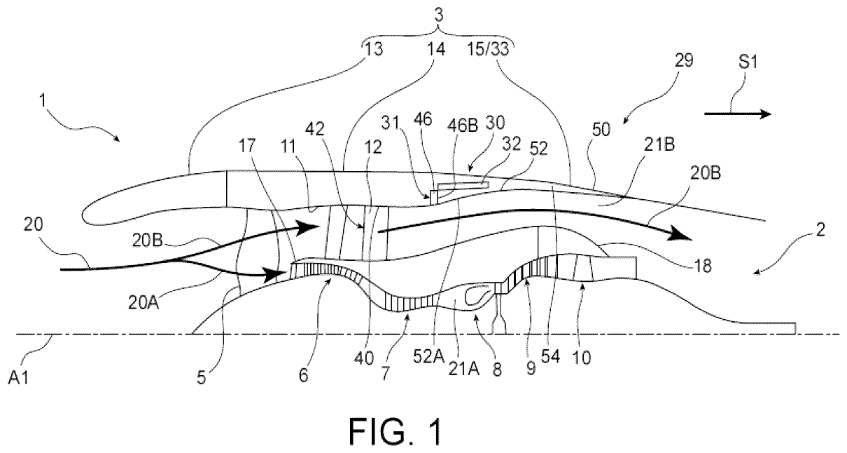

FIG. 1 shows an aircraft propulsion unit 1, having a longitudinal central axis A1.

Subsequently, the terms “upstream” and “downstream” are defined relative to a general direction S1 of flow of gases through the propulsion unit 1, along the axis A1 when the latter generates direct thrust. These terms “upstream” and “downstream” could respectively be substituted by the terms “front” and “rear”, with the same meaning.

The propulsion unit 1 comprises a turbomachine 2, a nacelle 3 and a mast (not shown), intended to connect the propulsion unit 1 to a wing (not shown) of the aircraft. In the present case, the propulsion unit is intended to be suspended under the aircraft wing by the mast, which is therefore located above the turbomachine in the vertical direction. However, other configurations are possible, such as laterally attaching this propulsion unit to the rear of the fuselage.

The turbomachine 2 is in this example a twin-spool, dual-flow turbojet engine comprising, from front to rear, a fan 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbojet engine 2 is provided with a fan casing 11 connected to the gas generator by structural arms 12.

The nacelle 3 comprises a front section forming an air inlet 13, a middle section which includes two fan cowls 14 enveloping the fan casing 11, and a rear section 15.

In operation, an air flow 20 enters the propulsion unit 1 via the air inlet 13, passes through the fan 5 then is divided into a primary flow 20A and a secondary flow 20B. The primary flow 20A flows in a primary gas circulation flow path 21A passing through the gas generator. The secondary flow 20B flows in a secondary flow path 21B surrounding the gas generator. The secondary flow path 21B is delimited radially inwards by a fixed internal fairing which envelops the gas generator. In this example, the fixed internal fairing comprises a first segment 17 belonging to the middle section 14, and a second segment 18 extending rearwards from the first segment 17, so as to form part of the rear section 15.

This second segment 18 is an integral part of a fixed structure of a thrust reverser which will be described below, also centered on the axis A1. This same segment will subsequently be called the radially internal delimiting wall 18 of the secondary flow path 21B.

Radially outward, the secondary flow path 21B is delimited by the fan casing 11. In the configuration of FIG. 1, two movable reverser cowls 33 form part of the rear section 15 of the nacelle 3. More precisely, between the fan casing 11 and the two reverser cowls 33, provision is made of an external shell 40 of an intermediate casing 42, the latter comprising the aforementioned structural arms 12, the radially external end of which is fixed to this shell 40. The latter therefore also participates in delimiting the secondary flow path 21B radially outward, by being located in the downstream axial extension of the fan casing 11.

The nacelle 3 therefore includes a thrust reverser 30 (shown only schematically and partially in FIG. 1), centered on the axis A1 and comprising on the one hand a fixed structure 31 secured to the fan casing 11, and on the other hand a structure 29 movable relative to the fixed structure 31. The fixed structure 31 includes for example a front frame 46 which connects it fixedly to the fan casing 11, preferably via a knife-edge assembly located downstream of the external shell 11. This front frame 46 contains a profiled aerodynamic part called a deflection edge 46B, which guides the flow in reverse jet.

In this preferred embodiment, the fixed structure 31 also includes a plurality of deflection cascades 32 arranged adjacent to each other around the axis A1, in a circumferential direction of the reverser 30 and of the propulsion unit 1.

Moreover, the movable structure 29 in turn comprises the two movable reverser cowls 33 mentioned above, corresponding to two cowls 33 of generally semi-cylindrical shape, and each extending over an angular amplitude of approximately 180°. This configuration with two cowls 33 is particularly well suited in the case of a nacelle design wherein the cowls/walls 18 are also mounted articulated, the reverser 30 then having an architecture called “D-shaped” architecture, known by the name “D-Duct”. In this architecture, the cowls 18, 33 are connected so as to open/close simultaneously during maintenance operations on the engine. However, other architectures are possible, such as for example an architecture called “C-shaped” architecture, known by the name “C-Duct”, and wherein the cowls 18 of the internal structure can be articulated independently of the two movable cowls 33.

Each movable reverser cowl 33 includes a radially external wall 50 forming an external nacelle aerodynamic surface, as well as a radially internal wall 52 participating in the delimitation of the secondary flow path 21B radially outwards. This wall 52 is located in the downstream continuity of the deflection edge 46B, in the direct thrust configuration. The two walls 50, 52 define a housing 54 open axially at the upstream end of the reverser cowl 33, and wherein at least part of the cascades 32 are located in the direct thrust configuration.

FIG. 1 shows the reverser 30 in a forward thrust configuration, called “direct jet”, corresponding to a standard flight configuration. In this configuration, the cowls 33 of the movable structure 29 are in a closed position, called the advanced thrust or “direct jet” position, wherein these reverser cowls 33 bear on the fixed structure 31, in particular on the deflection edge 46B forming an integral part of the latter. Indeed, in the direct thrust configuration, the upstream end 52A of the radially internal wall 52 of each cowl 33 bears axially against the deflection edge 46B.

The movable structure 29 is thus translatably movable relative to the fixed structure 31 along the axis A1 of the reverser, between the advanced direct thrust position shown in FIG. 1, and a retracted reverse thrust position which will be described later. In the advanced direct thrust position of the movable structure 29, the deflection cascades 32 are arranged in the housing 54 of the reverser cowls 33, being isolated from the secondary flow path 21B by the radially internal wall 52 of these sliding cowls 33. This wall 52, forming the external wall of the secondary flow path, is also called an acoustic internal panel.

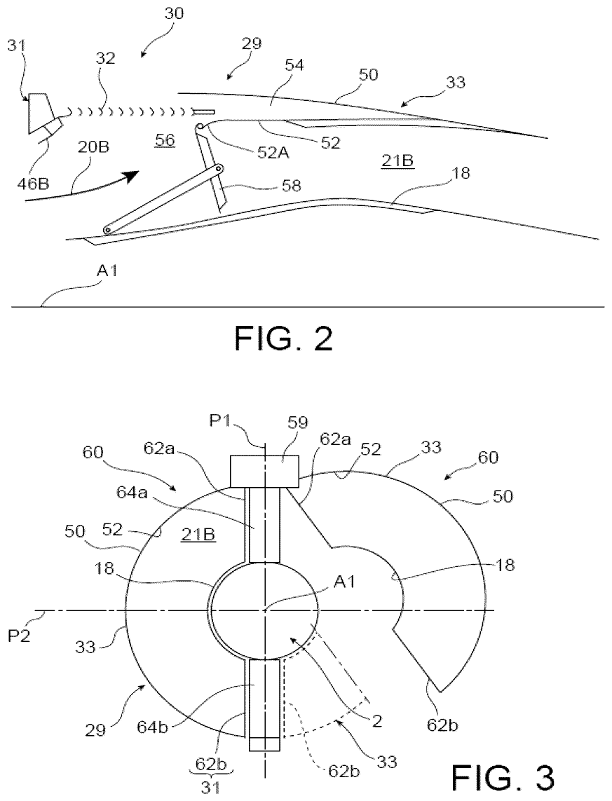

The retracted reverse thrust position of the movable structure 29 is shown in FIG. 2. In this figure, it is shown that the retracted internal acoustic panel 52 of the reverser cowls reveals upstream an opening 56 for passage of the secondary flow path 21B towards the deflection cascades 32. The opening 56 is therefore also delimited upstream by the deflection edge 46B, which flares radially outwards going towards the rear, to delimit an air flow intended to pass through the cascades 32 when the movable system is in this retracted reverse thrust position. In other words, the deflection edge 46B gradually moves away from the axis A1 going from the front to the rear, to guide/deflect the air towards the cascades 32 in the thrust reversal configuration.

In order to deflect at least part of the secondary flow 20B towards the passage opening 56 defined axially between the deviation edge 46B and the upstream end 52A of the radially internal wall 52 of each cowl 33, the reverser 30 conventionally includes doors 58 which are deployed into the flow path 21B. These doors 58, by closing the flow path, force at least part of the secondary flow 20B to be oriented towards the opening 56, and to pass through the fixed cascades 32 to obtain the desired counter-thrust function.

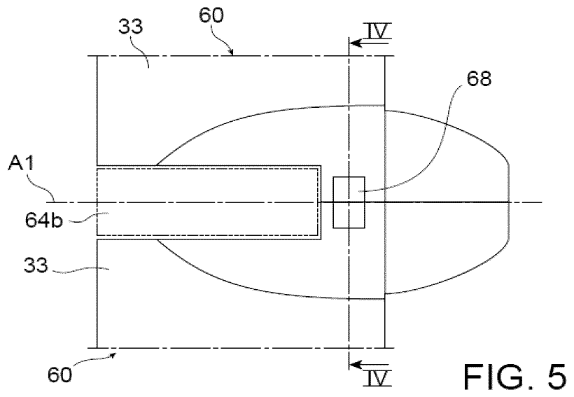

As indicated previously, the reverser has a D-shaped cowl configuration, namely that each cowl 33 forms an external cowl associated with an internal cowl formed by the wall 18. Each assembly can then be similar to a single cowl 60 articulated at the upper end on the attachment mast 59, so as to be able to pivot from a folded operating position to an open maintenance position, these positions being shown in FIGS. 3 to 5.

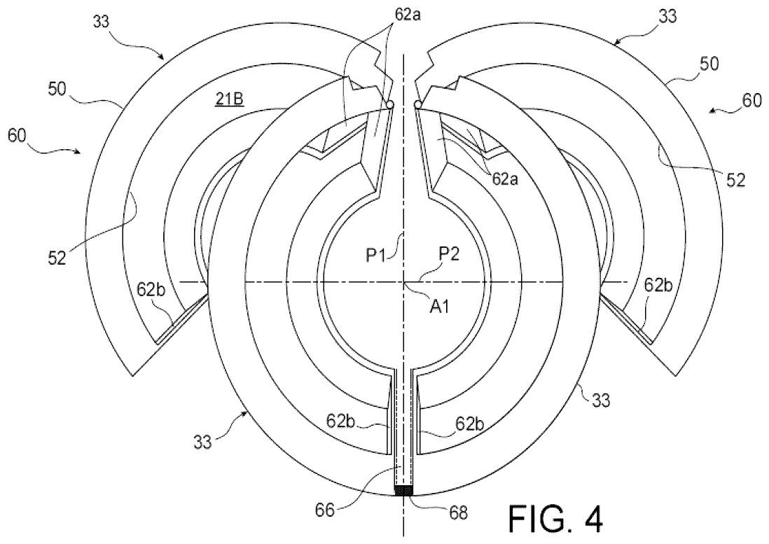

The two cowls 60 are arranged symmetrically with respect to a first median plane P1 of the reverser, this first imaginary plane here being a vertical and longitudinal plane, passing through the axis A1 and crossing the mast 59 in its middle. Each cowl 60 therefore comprises the movable external reverser cowl 33 and the fixed internal cowl 18, each having a semi-cylindrical shape. At their ends, the cowls 33, 18 are connected by an upper bifurcation 62a, as well as by a lower bifurcation 62b. The two cowls 60 are arranged on either side of the first median plane P1, and the two upper bifurcations 62a are also arranged at a distance on either side of this plane P1, for the passage of an upper fixed longitudinal beam 64a. The two upper bifurcations 62a are in a clock position close to 12 o'clock relative to the axis A1. Similarly, the two lower bifurcations 62b are also arranged at a distance on either side of the plane P1, for the passage of a lower fixed longitudinal beam 64b. The two lower bifurcations 62b are in a clock position close to 6 o'clock, still in relation to the axis A1. At the rear end of the cowls 60, behind the lower fixed beam 64b, the two lower bifurcations 62b are closer to each other, and the space defined therebetween is used for the installation of equipment and the passage of ancillaries 66, as can be seen at the bottom of FIG. 4. Preferably, the passage of the ancillaries is carried out over the entire length of the bifurcations. At these rear ends, the two movable cowls 33 are provided, close to the lower bifurcations 62b, with conventional locking means 68, also shown schematically in FIG. 4. These locking means 68 are crossed by the first median plane P1, and they allow to hold the two cowls 60 together in the folded operating position. In addition, by being located close to the lower bifurcations 62b, the cowl locking means are located on a first side of a second median plane P2 of the reverser, this second plane P2 being perpendicular to the first median plane P1 and also passing through the axis A1. In other words, the locking means 68 are located on the lower side of the second imaginary median plane P2, of longitudinal and transverse orientation.

Although forming part of the same articulated cowl 60, the two external and internal cowls 33, 18 that compose it are designed to be able to be moved axially relative to each other, in order to bring the reverser from the direct thrust configuration to the thrust reverser configuration, and vice versa. For this purpose, the reverser is equipped with a translational actuating system 70, allowing to move the entire movable structure 29 of the reverser relative to the fixed structure 31.

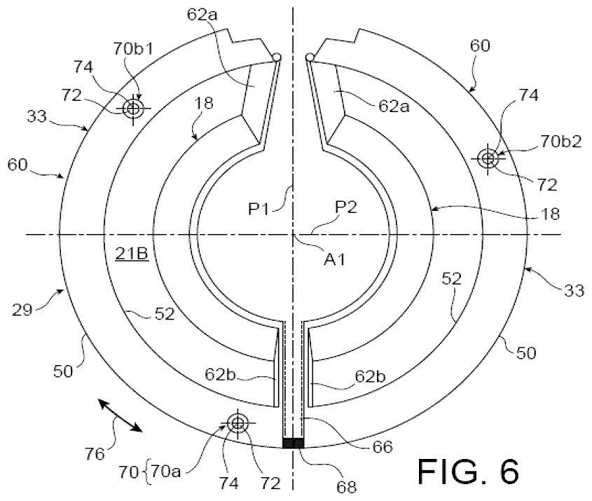

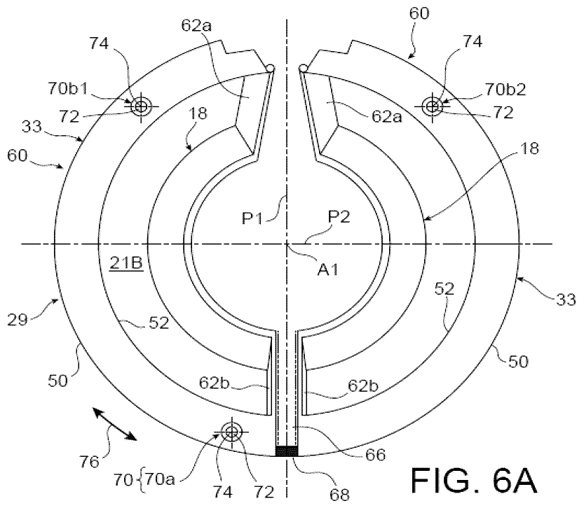

With reference now to FIG. 6, the actuating system 70 is shown, which therefore represents the only system within the reverser dedicated to the axial translational movement of the movable structure 29. The system 70 here consists of three actuators 70a, 70b1, 70b2, each equipped with an actuating member 72 that is translatably movable and centered on an actuating axis 74, of longitudinal orientation.

One of the particularities of the invention lies in the fact that the actuators 70a, 70b1, 70b2 no longer form a set of actuators symmetrical with respect to the first median plane P1, in particular because one of them forms an eccentric actuator 70a, arranged on the first side of the second median plane P2, corresponding to the side opposite to that where the mast is located. Indeed, the actuating axis 74 of the eccentric actuator 70a is offset circumferentially with respect to the first median plane P1, and it remains asymmetrical with respect to each of the two other actuators 70b1, 70b2 with respect to the first median plane P1. In other words, neither of these two other actuators 70b1, 70b2 of the actuating system 70 is arranged symmetrically relative to the eccentric actuator 70a, with respect to the first median plane P1.

In the case of three actuators selected for this embodiment, the eccentric actuator 70a is still located near the locking means 68, preferably in an angular position comprised between 155 and 175°. Preferably, the eccentric actuator 70a is arranged circumferentially offset relative to the lower bifurcation 62b of the cowl 60 with which this actuator 70a is associated, even if this offset in the circumferential direction 76, in the direction away from the other cowl 60, can remain small, or even very small.

Thanks to this particular positioning of the eccentric actuator 70a, in total rupture with the configurations known in the prior art, its installation is facilitated because it is carried out at a distance from the cluttered area where the locking means 68 are located, as well as the ancillaries and equipment 66 in the space between the two lower bifurcations 62b.

The two other actuators 70b1, 70b2 constituting the actuating system 70 are in turn arranged on the same second side of the second median plane P2, namely on the upper side where the mast 59 is located, and also on either side of the first plane P1. Together, the three actuators 70a, 70b1, 70b2 can be distributed regularly relative to each other in the circumferential direction 76, as can be seen in FIG. 6, even if other arrangements remain possible, without departing from the scope of the invention. In the case of a regular distribution, the two other actuators 70b1, 70b2 are therefore asymmetrical with respect to the first median plane P1.

In this regard, it is noted that the distribution of the actuators is essentially dictated by the recovery of the aerodynamic forces on the cowls 60, in particular in the thrust reversal configuration.

Another preferred configuration is shown in FIG. 6A. It consists in providing that the two actuators 70b1, 70b2 are arranged symmetrically with respect to each other, in relation to the first median plane P1. This configuration reduces the risks of jamming of the cowls during their translation, since the distance between each of these two actuators and their associated guiding system is identical or substantially identical.

In the embodiment which is described, the number of actuators 70a, 70b1, 70b2 constituting the actuating system 70 is fixed at three, but it could be different, for example five, while remaining an odd number with an optimized distribution so as to limit the number, for savings in costs and mass.

It is noted that the actuators 70a, 70b1, 70b2, preferably oriented parallel to the axis A1, are of conventional design, for example in the form of electric cylinders, hydraulic cylinders, or else ball or roller screws.

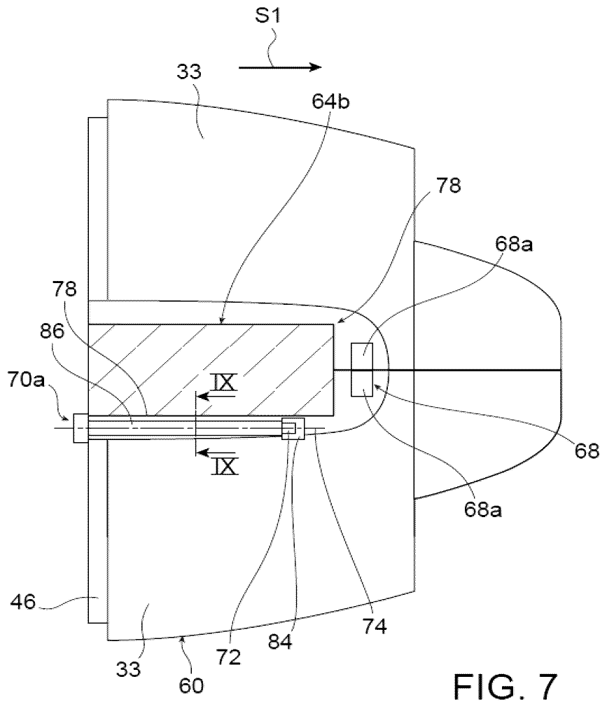

With reference now to FIGS. 7 to 9, the cowl 60 is shown cooperating with the eccentric actuator 70a. This articulated cowl 60 has its movable cowl 33 equipped with a beam 78 of general axial orientation, and located on a lower edge of this movable cowl 33. The beam 78 has the particularity of offering several functions, which will be described below.

First of all, the main axially oriented part of the beam 78 fixedly carries means 80 for guiding the movable cowl 33 in translation. These guide means 80, for example in the form of a rail, cooperate with a complementary rail 82 fixed on a lateral flank of the fixed beam 64b, to allow satisfactory guiding of the movable structure 29 in translation. It is noted that preferably, the eccentric actuator 70a is therefore also arranged circumferentially offset in the direction going away from the other cowl 60, relative to the guide means 80 and to the rail 82.

In addition to securing the guide means 80 to the beam 78 of the movable cowl 33, an attachment fitting 84 of the movable actuating member 72 of the eccentric actuator 70a is also secured to the main axially oriented part of the beam 78, preferably towards the rear.

Finally, at a rear end of the beam 78, curved until it adopts a circumferential orientation and delimiting the housing space of the fixed beam 64b axially towards the rear, a part 68a of the locking means 68 is secured to this rear end of the beam 78.

On the other cowl 60, similar means are secured to its beam 78, with the exception of the attachment fitting 84 of the movable actuating member 72.

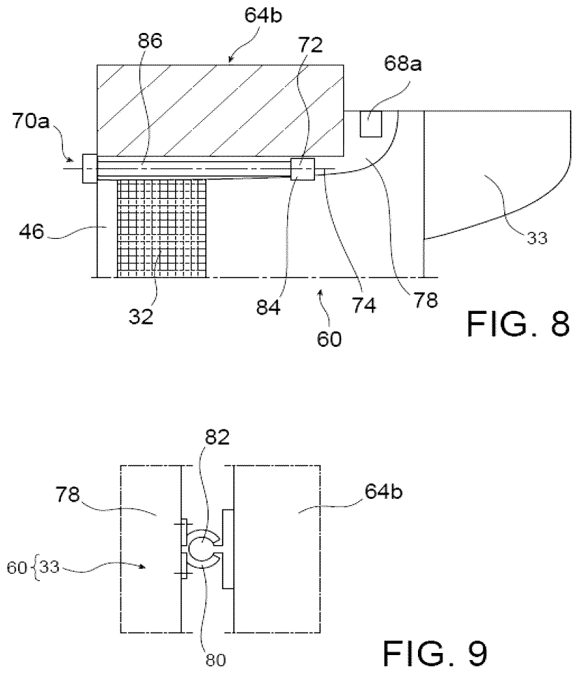

In FIGS. 7 and 8, provision is made to fix the fixed part 86 of the eccentric actuator 70a on the front frame 46 supporting the cascades 32. More precisely, this fixed part 86 of the actuator 70a has a front end fixed on the front frame 46 supporting the cascades, and it projects axially towards the rear.

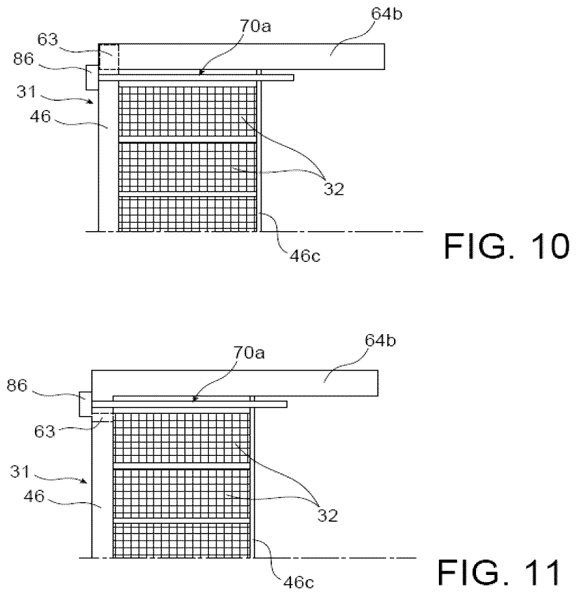

Alternatives are shown in FIGS. 10 and 11. In FIG. 10, the fixed part 86 of the eccentric actuator 70a remains fixed to the front support frame 46 of the cascades 32. The dotted junction 63 between the beam 64b at the hourly position at 6 o'clock, and the front support frame 46 of the cascades 32, is angularly located between the eccentric cylinder 70a, and the beam 64b.

In FIG. 11, the fixed part 86 of the eccentric actuator 70a is fixed near the front support frame 46 of the cascades 32, on the fixed beam 64b, at a circumferential protrusion thereof. The junction area 63 between the beam 64b and the front support frame 46 of the cascades 32 is then angularly/circumferentially offset from the cylinder 70a, in the direction opposite the other cowl 60.

The cascades 32 may be offset slightly circumferentially from the fixed beam 64b, in order to provide the space necessary for housing the fixed actuator part 86.

The following figures show different technical solutions for limiting the risks of bending of one or both movable cowls 33, in the event of a malfunction of one or more actuators 70a, 70b1, 70b2. Indeed, these actuators being guarantors of maintaining the movable cowls 33 in position, and even of all the cowls 60, in particular in the thrust reversal configuration, specific means can be implemented to avoid such bending likely to occur under the effect of the aerodynamic forces exerted on the cowls.

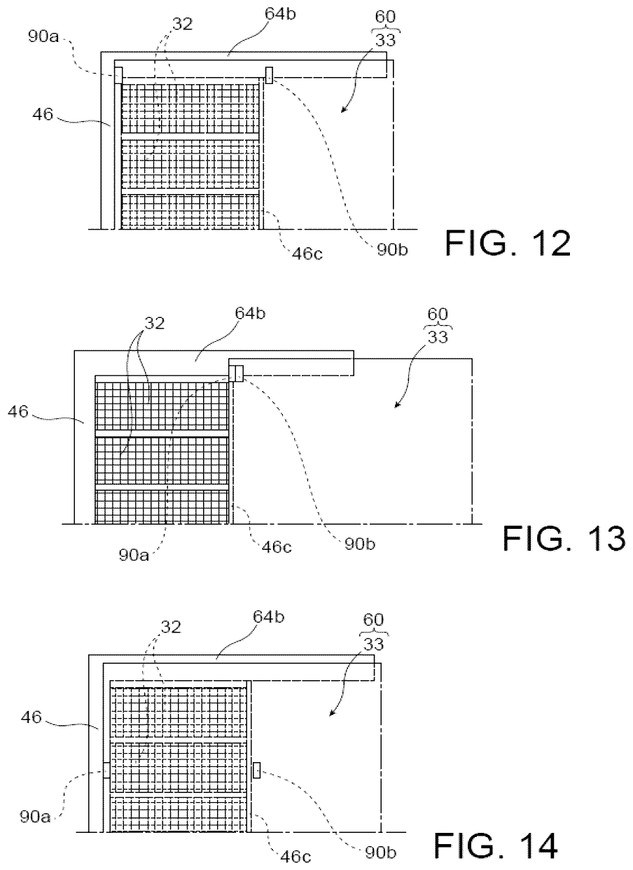

In FIGS. 12 and 13, a first solution consists in placing an axial stop 90a on a front end of the movable cowl 33, as well as a complementary axial stop 90b on the fixed beam 64b. The two stops 90a, 90b are intended to be contacted only in the retracted reverse thrust position of the movable cowl 33. In addition, several pairs of stops of this type are preferentially distributed circumferentially around the axis A1, in a regular or irregular manner.

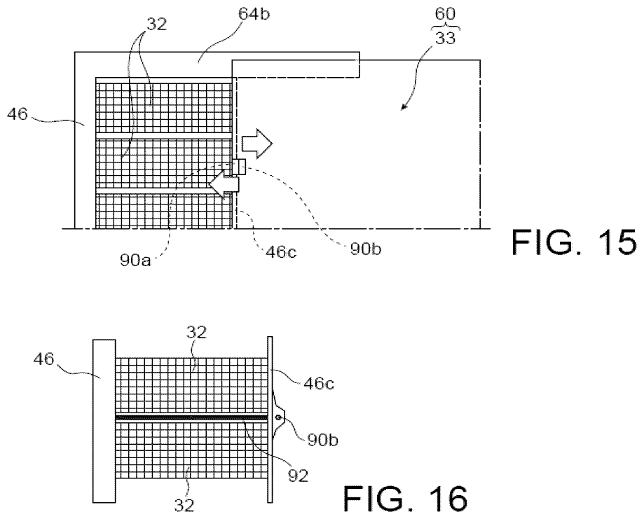

In FIGS. 14 and 15, the complementary axial stop 90b is located on a rear frame 46c supporting the cascades 32.

Finally, in FIG. 16, the complementary axial stop 90b is still located on the rear frame 46c supporting the cascades 32, but it is connected to an axial spar 92 located between the cascades 32. This spar 92 transmits the forces undergone by the stop 90b directly into the front support frame 46, to provide better force absorption.

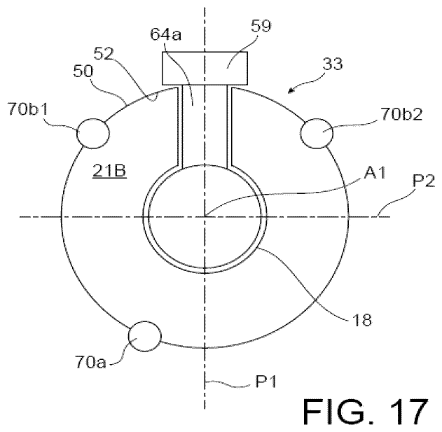

Various modifications may be made by the person skilled in the art to the invention which has just been described, only by way of non-limiting examples, and the scope of which is defined by the appended claims. For example, the thrust reverser 30 may alternatively have a “C” architecture, still with two movable cowls 33, or an “O” architecture with a single movable cowl 33 extending over an angular amplitude close to 360°, and being interrupted only at the hourly position at 12 o'clock by the upper fixed longitudinal beam 64a, as has been shown schematically in FIG. 17. As another example, the propulsion unit could be arranged laterally in the rear part of the fuselage.

In addition, all the features disclosed above, in the various embodiments and their alternatives, are combinable with each other. Moreover, it is noted that in all the figures which have been described above, the elements which bear the same numerical references correspond to identical or similar elements.

1. A propulsion unit for an aircraft, comprising a turbomachine, a nacelle including at least one fan cowl, a mast for attaching the turbomachine, as well as a thrust reverser comprising a fixed structure equipped with a radially internal delimiting wall of a secondary flow path of the propulsion unit intended to be traversed by a secondary flow, the reverser also comprising a movable structure comprising one or two movable reverser cowls each equipped with a radially internal reverser cowl wall delimiting the secondary flow path radially outwards, the reverser also comprising at least one deflection cascade, the movable structure being translatably movable relative to the fixed structure along a longitudinal central axis of the reverser, between an advanced direct thrust position and a retracted reverse thrust position, the reverser comprising an actuating system for moving the movable structure between its advanced direct thrust position and its retracted reverse thrust position, the actuating system consisting of one or more actuators each comprising an actuating member that is translatably movable and centered on an actuating axis, the reverser having a first median plane of the reverser passing through the longitudinal central axis and crossing the attachment mast, as well as a second median plane of the reverser passing through the longitudinal central axis and perpendicular to the first median plane,
wherein among said actuator(s) of the actuating system, provision is made of an eccentric actuator arranged on a first side of the second median plane opposite a second side of the second median plane where the attachment mast is located, and the actuating axis of which is offset circumferentially with respect to the first median plane,
wherein, in the case of several actuators constituting the actuating system, the eccentric actuator is asymmetrical with respect to each of the other actuators relative to the first median plane,
and wherein the actuating system consists of an odd number of actuators, the actuators being distributed relative to each other circumferentially in a regular or irregular manner.

2. The propulsion unit according to claim 1, wherein the actuating system consists of three actuators, including:
the eccentric actuator;
two other actuators arranged on either side of the first median plane, symmetrically with respect to this first median plane.

3. The propulsion unit according to claim 1, wherein one of said two movable reverser cowls includes a beam on which are secured:
means for guiding the movable reverser cowl in translation;
an attachment fitting for the movable actuating member of the eccentric actuator;
a part of the locking means for the two movable cowls.

4. The propulsion unit according to claim 1, wherein a fixed part of the eccentric actuator is fixed on a front frame of the deflection cascade support, or on a fixed longitudinal beam of the reverser, extending rearwardly from the front frame of the cascade support.

5. The propulsion unit according to claim 1, wherein the propulsion comprises, associated with at least one of said one or two movable reverser cowls, at least one member for limiting the bending of said movable cowl in the retracted reverse thrust position, in the event of a malfunction of one or more actuators.

6. The propulsion unit according to claim 1, wherein the reverser has a C-shaped, D-shaped or O-shaped cowl architecture.
